(19) United States
(12) Patent Application Publication
(10) Pub. No.: US 2026/0050932 A1
(43) Pub. Date: Feb. 19, 2026

(54) METHODS, SYSTEMS AND COMPUTER PROGRAM PRODUCTS FOR PERFORMING A REGULATORY VALIDATION PROCESS

(71) Applicant: ezVal Inc., Rockville, MD (US)

(72) Inventors: Carla Rampy, Potomac, MD (US); Muhammad Shafile Rashid, Frederick, MD (US); Emily Ridgely, Hartfield, VA (US)

(21) Appl. No.: 19/302,530

(22) Filed: Aug. 18, 2025

Related U.S. Application Data
(60) Provisional application No. 63/683,762, filed on Aug. 16, 2024.
(60) Provisional application No. 63/766,545, filed on Mar. 4, 2025.

(51) Int. Cl. G06Q 30/018

(52) U.S. Cl. CPC G06Q 30/018

(57) ABSTRACT

A computer-implemented method for performing a regulatory validation process is provided. The method includes receiving, via a web-based application, a request to initiate a validation study for a selected asset or process; retrieving, from a validation protocol database, a pre-approved validation protocol corresponding to a type of the selected asset or process; displaying, via a user interface, one or more verification tests of the validation protocol, each verification test having associated instructions, acceptance criteria, and/or required data entry fields; receiving, from an authenticated user, input data for at least one of the verification tests; receiving an electronic signature from the authenticated user, the electronic signature being applied using multi-factor authentication; automatically recording the user input data, electronic signature, and corresponding timestamps in an audit trail database; and generating, responsive to completion of the validation protocol, an electronic validation report in a compliance-ready format.

### CROSS-REFERENCE TO RELATED APPLICATION

This application claims priority to and the benefit of U.S. Provisional Application No. 63/683,762, filed on Aug. 16, 2024 and U.S. Provisional Application No. 63/766,545 filed on Apr. 4, 2025, the contents of which is hereby incorporated herein by reference in its entirety.

### BACKGROUND

Validation is a critical step in compliance, for example, biotech and pharmaceutical compliance, and often slows innovation and drains resources due to its reliance on tedious, manual workflows or expensive consultants. Ensuring that laboratory and manufacturing equipment, storage systems, and production processes meet strict regulatory standards is essential but tedious, expensive and oftentimes inefficient. The process generally involves creating, executing, and documenting extensive test protocols to prove compliance with safety and quality standards. Without streamlined solutions, established and emerging biotech firms face delayed product launches, wasted resources, regulatory risk and prolonged patient access to life-saving therapies.

These long and tedious Validation processes are generally performed using pen and paper. These processes vary from industry to industry. Generally, a company may create a unique validation process for the company based on guidelines set out by, for example, the food and drug administration (FDA). Once the arduous process is completed by hand, the process must be checked by another person to ensure all the details are correct. The process may take three (3) months or more to complete using conventional techniques. Improved validation processes are desired.

### SUMMARY

In some embodiments of the present inventive concept provide a computer-implemented method for performing a regulatory validation process. The method includes receiving, via a web-based application, a request to initiate a validation study for a selected asset or process; retrieving, from a validation protocol database, a pre-approved validation protocol corresponding to a type of the selected asset or process; displaying, via a user interface, one or more verification tests of the validation protocol, each verification test having associated instructions, acceptance criteria, and/or required data entry fields; receiving, from an authenticated user, input data for at least one of the verification tests; receiving an electronic signature from the authenticated user, the electronic signature being applied using multi-factor authentication; automatically recording the user input data, electronic signature, and corresponding timestamps in an audit trail database; and generating, responsive to completion of the validation protocol, an electronic validation report in a compliance-ready format.

In further embodiments, the selected asset or process may include at least one of: laboratory equipment, manufacturing equipment, a production process, a shipping method, a computerized system, controlled temperature units (CTUs) or a utility system.

In still further embodiments, the method may further include storing the electronic validation report in a cloud-based data storage service with geo-redundant backup.

In some embodiments, the validation protocol may be pre-configured based on quality management system (QMS) requirements related to a specific organization.

In further embodiments, the method may further include receiving a deviation request when test results fall outside predetermined acceptable criteria; routing the deviation request to designated personnel for review and approval; and storing deviation approval data in the audit trail database.

In still further embodiments, the multi-factor authentication may include sending a one-time password (OTP) to a registered communication address of the authenticated user.

In some embodiments, the method may further include assigning role-based access permissions to the authenticated user prior to initiating the validation study.

In further embodiments, the compliance-ready format may be a portable document format (PDF) file generated automatically by the application.

In still further embodiments, the method may further include analyzing historical validation data using a machine learning model to recommend a validation protocol for the selected asset or process.

In some embodiments, the one or more verification tests may include dynamically generated acceptance criteria predicted by a trained machine learning algorithm based on asset-specific operating history.

In further embodiments, the trained machine learning algorithm may be trained using a plurality of prior validation studies across multiple organizations to predict optimal test sequences that minimize total validation time while maintaining compliance.

In still further embodiments, the method may further include retraining the machine learning model with results of completed validation studies to improve accuracy of future protocol recommendations.

In some embodiments, the method may further include automatically detecting anomalies in received input data using an artificial intelligence (AI) anomaly detection model; and generating a deviation request responsive to detection of the anomalies.

In further embodiments, the artificial intelligence (AI) detection model may provide real-time guidance to the authenticated user during execution of the validation protocol based on context-aware analysis of current test results.

In still further embodiments, the method may further include using a natural language processing model to parse unstructured regulatory guidance documents and extract protocol requirements for storage in the validation protocol database.

Some embodiments of the present inventive concept provide a system for performing a regulatory validation process. The system includes a processor; and a memory that stores instructions that, when executed by the processor, cause the system to: receive, via a web-based application, a request to initiate a validation study for a selected asset or process; retrieve, from a validation protocol database, a pre-approved validation protocol corresponding to a type of the selected asset or process; display, via a user interface, one or more verification tests of the validation protocol, each verification test having associated instructions, acceptance criteria, and/or required data entry fields; receive, from an authenticated user, input data for at least one of the verification tests; receive an electronic signature from the authenticated user, the electronic signature being applied using multi-factor authentication; automatically record the user input data, electronic signature, and corresponding timestamps in an audit trail database; and generate, responsive to completion of the validation protocol, an electronic validation report in a compliance-ready format.

Further embodiments of the present inventive concept provide a non-transitory computer-readable medium storing instructions that, when executed by a processor, cause a computing system to: receive, via a web-based application, a request to initiate a validation study for a selected asset or process; retrieve, from a validation protocol database, a pre-approved validation protocol corresponding to a type of the selected asset or process; display, via a user interface, one or more verification tests of the validation protocol, each verification test having associated instructions, acceptance criteria, and/or required data entry fields; receive, from an authenticated user, input data for at least one of the verification tests; receive an electronic signature from the authenticated user, the electronic signature being applied using multi-factor authentication; automatically record the user input data, electronic signature, and corresponding timestamps in an audit trail database; and generate, responsive to completion of the validation protocol, an electronic validation report in a compliance-ready format.

### BRIEF DESCRIPTION OF THE DRAWINGS

FIG. 1 is a block diagram illustrating an example system architecture in accordance with some embodiments of the present inventive concept.

FIG. 2 is an example entity relation diagram in accordance with some embodiments of the present inventive concept.

FIG. 3 is an example validation home screen in accordance with some with some embodiments of the present inventive concept integrated in a storage unit of a device.

FIG. 4 is a table that includes details related to example verification tests in accordance with some embodiments of the present inventive concept.

FIG. 5 is a table that includes details related to system requirements in accordance with some embodiments of the present inventive concept.

FIG. 6 is a flowchart illustrating processes in accordance with some embodiments of the present inventive concept.

FIG. 7 is a diagram illustrating the repeatable process in accordance with some embodiments of the present inventive concept.

FIG. 8 is a chart illustrating the various steps in the full IOQ documentation in accordance with some embodiments of the present inventive concept.

FIG. 9 is a diagram illustrating the deployment methodology in accordance with some embodiments of the present inventive concept.

FIG. 10 is a flowchart illustrating processing steps in a conventional paper process.

FIG. 11 is a flowchart illustrating processing steps in the computerized process in accordance with embodiments discussed herein.

FIG. 12 is a flowchart illustrating various operations in accordance with some embodiments of the present inventive concept.

FIG. 13 is a block diagram of a data processing system for use in accordance with some embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

As will be appreciated by one of skill in the art, the inventive concept may be embodied as a method, data processing system, or computer program product. Accordingly, the present inventive concept may take the form of an entirely hardware embodiment or an embodiment combining software and hardware aspects all generally referred to herein as a “circuit” or “module.” Furthermore, the present inventive concept may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present inventive concept may be written in an object-oriented programming language such as .NET, Java®, Smalltalk or C++. However, the computer program code for carrying out operations of the present inventive concept may also be written in conventional procedural programming languages, such as the “C” programming language or in a visually oriented programming environment, such as VisualBasic or JavaFx.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The inventive concept is described in part below with reference to a flowchart illustration and/or block diagrams of methods, systems and computer program products according to embodiments of the inventive concept. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

As discussed in the background of the present inventive concept, validation processes can be long and cumbersome processes that are generally performed using pen and paper. These processes vary from industry to industry. Generally, a company may create a unique validation process for the company based on guidelines set out by, for example, the food and drug administration (FDA). Once the arduous process is completed by hand, the process must be checked by another person to ensure all is correct.

Accordingly, some embodiments of the present inventive concept provide methods, systems and computer program products that present an efficient and compliant validation solution. In particular, embodiments of the present inventive concept provide methods, systems and computer program products that streamline a validation process for a selected asset or process. As used herein, the selected asset or process can be any asset or process that requires validation, for example, controlled temperature units or biotech and pharmaceutical compliance. As used herein, controlled temperature units include, for example, refrigerators; freezers; ultra-low freezers; walk-in controlled temperature storage rooms; LN2 Freezers, incubators and the like. Biotech and pharmaceutical compliance may relate to, for example, new drugs or medical devices that are going through FDA approval. It will be understood that these assets and processes are provided as examples only and embodiments discussed herein are not limited thereto. Embodiments of the present inventive concept provide a web-based software application designed to streamline the validation process of these assets and/or processes that is conventionally done with pen and paper as will be discussed further herein.

Although some embodiments of the present inventive concept will be discussed with respect to validation processes for controlled temperature units or pharma compliance, embodiments of the present inventive concept are not limited thereto. For example, validation processes discussed herein may be used for autoclaves, analytical instruments, shipping methods (shipping validation), process validation, computerized systems, equipment and utilities and the like without departing from the present inventive concept.

Some embodiments of the present inventive concept provide a products that is designed specifically for the selected asset or process, for example, the performance of controlled temperature unit validation studies. The product may provide creation and management of validation study data; report generation features; data import functions; data parsing functions; administrative controls (Users, Roles etc.) and regulatory compliance (Audit Trails, E-Signatures etc.). In some embodiments, the application is a cloud-based application that does not require coding by the customer and is secure and compliant.

Details with respect to some embodiments of the present inventive concept will be described herein to provide an overview of the configuration of a web-based software application design to streamline validation. For example, some embodiments provide configuration details of the application infrastructure in a cloud-based environment from a high-level point of view.

As discussed above, companies generally develop internal validation procedures. Thus, systems in accordance with embodiments discussed herein are designed for specific company and product needs. For example, the infrastructure may include intended service levels and data centers. In some embodiments, the intended service level for “uptime” may be 99%. As used herein, “uptime” refers to a time during which a service or data center is in operation. It will be understood that “downtime,” i.e., not in operation, for this definition is considered to be unplanned downtown and does not include scheduled downtime for maintenance and upgrades.

In some embodiments, the data centers may be Azure data centers for the software as a service (SaaS) Infrastructure. Azure Site Recovery (ASR) may be provided, which is a service that ensures business continuity by keeping business applications and workloads running during outages. ASR replicates workloads running on physical and virtual machines (VMs) from a primary site to a secondary location.

As used herein, replication is continuous replication of on-premises servers or Azure VMs to a different Azure region. For example, for East US, the application may be paired and replicated to the West US site. The system also includes failover and failback, which includes automated and manual failover processes to switch operations to the secondary site during an outage and failback when the primary site is restored. The system provides data consistency that ensures that data is replicated with application-consistent snapshots, maintaining the integrity of the data.

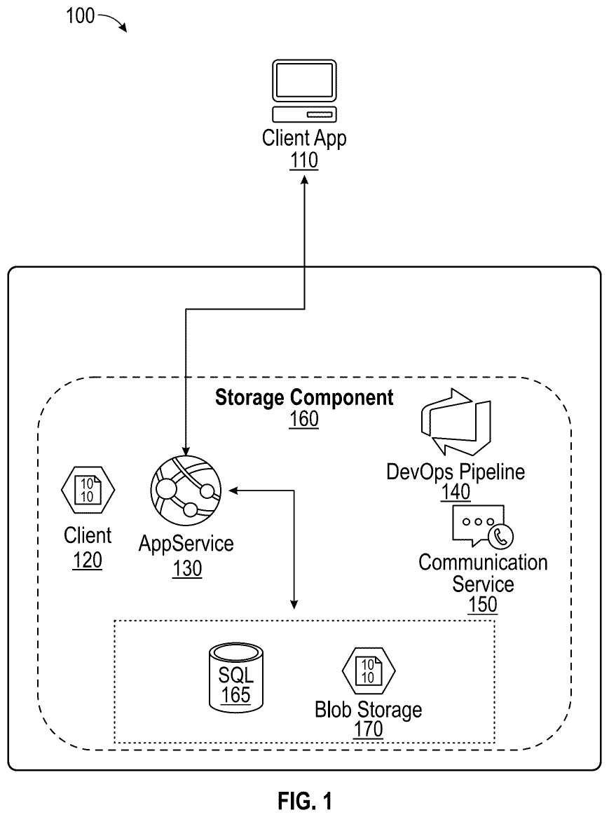

Referring now to FIG. 1, an example system architecture 100 will be discussed. The system 100 of FIG. 1 is provided as an example only and, therefore, embodiments discussed herein are not limited thereto. As illustrated in FIG. 1, the system 100 includes a client application 110, a client 120, an application service 130, a DevOps pipeline 140, a communication service 150, and a storage component 160 including a structure query language (SQL) 165 and blob storage 170. Embodiments are not limited to the example of FIG. 1. For example, more than one client application may be present.

As used herein, “blob storage,” also known as object storage, is a cloud storage solution optimized for handling large amounts of unstructured data. Blob storage is designed to store large binary objects, like images, videos, audio files, and backups, without requiring a predefined data model. This makes it highly flexible and scalable for various applications, including big data analytics, data lakes, and long-term archival.

SQL is a standardized programming language specifically designed for managing and manipulating relational databases. It serves as the primary means of communication with relational database management systems (RDBMS), for example, MySQL, PostgreSQL, Oracle, and SQL Server.

In some embodiments, the DevOps pipeline 140 is an Azure® DevOps pipeline and the communication service 150 is an Azure® communication service. However, embodiments are not limited thereto, any cloud computing platform that offers management, access and development of applications and services can be used without departing from the scope of the present inventive concept.

In embodiment using Azure®, the system may provide Azure Business Continuity and Disaster Recovery (BCDR). This may be a comprehensive approach to BCDR to help ensure applications remain available during planned and unplanned disruptions. The system provides geo-redundant storage (GRS) to replicate data across regions, ensuring high availability even if the primary region is impacted. A DNS-based traffic load balancer is provided that distributes traffic optimally to services across global Azure regions while providing high availability and responsiveness (Azure Traffic Manager).

In these embodiments, the blob storage is Azure Blob storage. The Azure blob storage backups databases and provides configuration to provide a secure, robust recovery model. Backups may be replicated to an alternative Azure region to provide redundancy against the failure of an entire Azure region. All databases are backed up by automated backup jobs which immediately push the backup file to the Azure Blob storage location. All backups may be encrypted. Backups may be scheduled, for example, a full backup may be performed weekly at off hours and differential backup may be performed every 6 hours. However, embodiments of the present inventive concept are not limited to this schedule. Backups may be performed at any time and any frequency without departing from the scope of the present inventive concept.

The database backups are stored. In some embodiments, database backups may be stored as follows: up to two weeks: all backup files may be maintained on Azure Blob Storage; up to 1-month, weekly backups stored on Azure Blob. Application configuration settings may be stored in the application database and may be backed up using the above process.

In some embodiments, Azure data centers, including East US, are compliant with ISO/IEC 27001, SOC 1, SOC 2, and many other standards. Audit reports and compliance documents may be accessed through the Azure Service Trust Portal.

In some embodiments, Representational State Transfer (REST) application programming interfaces (APIs) may be used (NET 6 Web API) for backup development. REST API is a software architectural style for API that uses HTTP requests to access and use data. REST APIs are common APIs used across the web today and are considered easier to use than other protocols like Simple Object Access Protocol (SOAP). They are generally faster, lightweight, and have increased scalability. However, embodiments of the present inventive concept are not limited thereto.

Entity Framework may be used as the Object-Relational Mapper (ORM) to facilitate data access and manipulation. Aspose PDF may be used to parse PDF files. Aspouse PDF is a commercial utility known for its robust features. Aspose.PDF meets the requirements for extracting data from PDF files effectively. This library is well-maintained and reliable, providing excellent support and covering most of the use cases for PDF processing. FIG. 1 is a diagram illustrating the system architecture discussed above in accordance with some embodiments of the present inventive concept will be discussed.

Some embodiments of the present inventive concept include two environments: development and production. The development environment may be used for testing, bug fixes and new features.

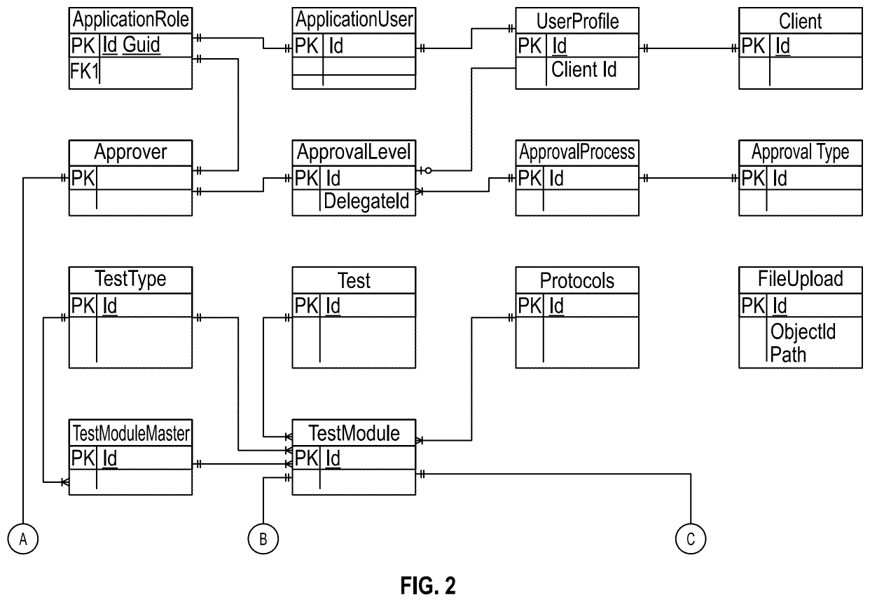

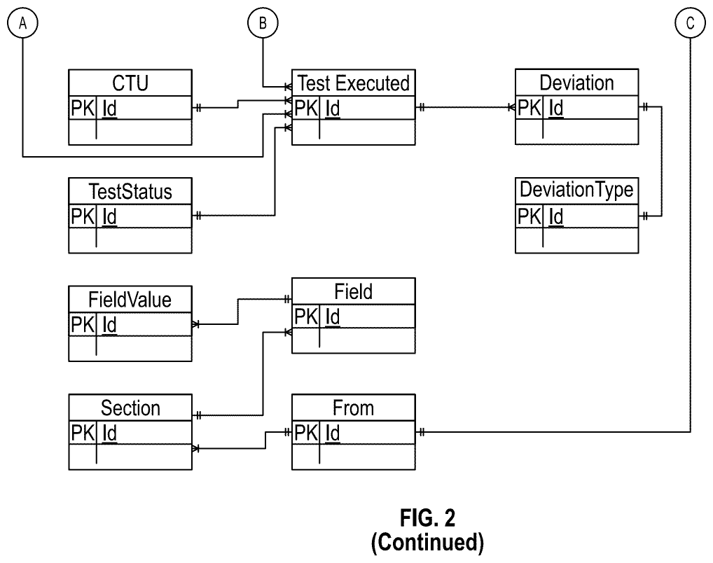

In some embodiments, the database may be a Microsoft SQL Server 18, but embodiments are not limited thereto. FIG. 2 illustrates data relations and how tables of the system relate to each other.

Standard procedures for performing ongoing operations within the application will now be discussed. It will be understood that the following procedures are provided as examples only and the procedures in accordance with embodiments discussed herein are not limited to these exact procedures. These procedures are directed toward personnel who are involved in the management and validation of assets using embodiments of the present inventive concept. In particular, the standard operating procedure (SOP) applies to the configured protocols, which are specifically designed to meet the requirements set forth for the computer system.

Access to the application discussed herein may be granted based on completion and approval of internal procedures. Role assignments are delegated by, for example, the department manager. In some embodiments, only the site administrator can create new user accounts. Additional site administrator accounts may be needed and can be created by the super administrator.

When a user first logs into the system, the company (site) administrator creates the User Login record (create new user) using administrator credentials and initiates the user creation process. Required fields, such as full name, email, user role and the like, are filled out. A user's role may be selected from a drop-down menu in some embodiments. Example roles include quality assurance, admin, system owner, validation engineer view user and the like. Each role may be associated with specific privileges and these privileges may be customizable.

User roles are ways of characterizing users and specifying the access privileges for users. When an account is created, access privileges are provided to the new user by assigning a user role. Only one (1) user role can be assigned to a single user. In some embodiments, a picture of the user may be uploaded.

Once a welcome email is received by the user, the user may press, for example, “the Click Here button,” to create the new user password. Generally, passwords are required to meet predetermined criteria. For example, in some embodiments, passwords are required to meet the following criteria: minimum eight (8) characters; at least one uppercase letter; at least one lowercase letter; and at least one special character. Once complete, users may be prompted to enter their email and newly created password. In some embodiments, the system may also offer a strong password so that the user can select the offered password rather than create their own.

In some embodiments, a one-time password (OTP) may be immediately emailed to the user. The OTP code is entered into the OTP field on the login screen. This OTP serves as a personal PIN code when applying e-signatures. It will remain the active PIN code throughout the user session. However, in further embodiments, a user may have their password and a user-generated PIN that may be saved in the user's profile page. This may be used a third or more method of identification.

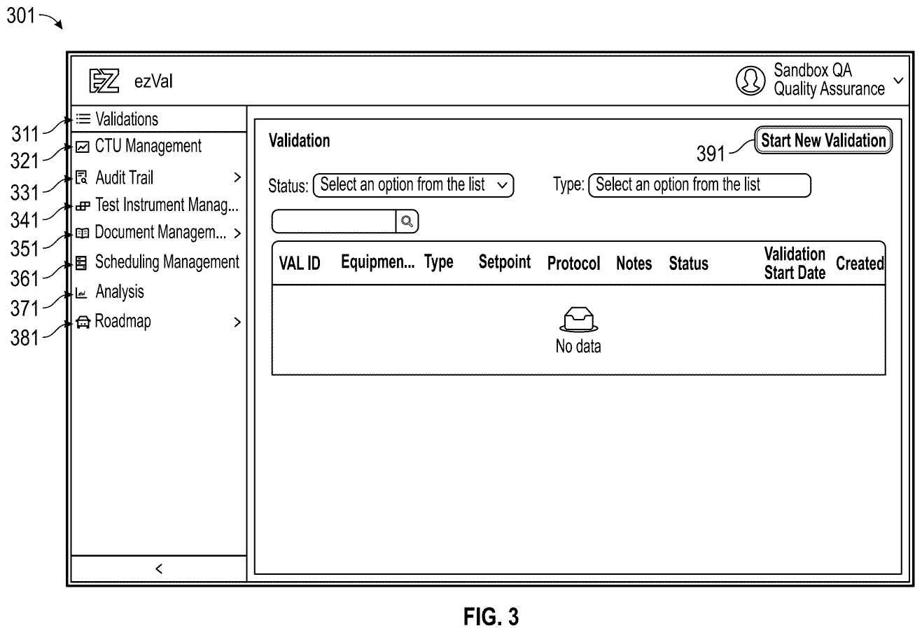

Referring now to FIG. 3, an example of a validation “Home” screen 301 that is provided responsive to a successful login is illustrated. This particular validation home screen 301 is related to a validation of controlled temperature units, however, embodiments are not limited thereto. It will be understood that FIG. 3 is provided for example only and embodiments of the present inventive concept are not limited to the configuration thereof.

Once all the details of the first login are completed, subsequent logins are not as lengthy. Subsequent logins may involve launching a browser, for example, Chrome. An address, for example, https://czval.azureedge.net/may be entered in the address bar. The user credentials discussed above are entered and a PIN code is requested.

When a user has completed their tasks within the system, the user can log out. For example, in some embodiments, a user may select “Log Out” from, for example, a drop down menu at the top right of the validation home screen. Any menu may be used without departing from the scope of the present inventive concept.

A user may update their profile at any time. For example, a user may provide an e-signature by, for example, selecting in the top right of the Validation home page-User Profile. A user may select editing e-Signature and the signature may be updated using the mouse to create a unique signature.

A user's access can be removed at any time. For example, from the User Management screen, the user you want to remove access from is selected. In the User profile page, toggle the User State switch to grey, select the Update User button to save. The user is now inactive. This series of steps is provided for example only.

Only active users are able to log in to the system. The site administrator can perform changes to configuration settings under change control upon approval of the change control request. For example, the following configuration changes may be under change control: changes to the protocol verification tests.

Referring again to FIG. 3, the left panel of the Validation Home page 301 displays icons associated with different functions of the computer system. It will be understood that the icons can be displayed anywhere on the screen and not just on the left panel.

In some embodiments, toolbar icons may be used to navigate the main functional areas of the computer system. Example icons are listed below with their corresponding functions:

[symbol] Validations icon 311 represents the home page for displaying all active and completed validation studies also for initiating any new validation studies.

[symbol] CTU Management icon 321 represents the area for adding controlled temperature units (CTUs) to be managed through the computer system.

[symbol] Audit Trail icon 331 represents the area of the computer system which automatically records actions and modifications made by users within the computer system.

[symbol] Test Instrument Management icon 341 represents the area for adding instrument information for test equipment used in association with the validation study.

[symbol] Document Management icon 351 represents the area for adding SOPs, technical reports, guidance/standards or any other documentation pertinent to the validation study.

[symbol] Scheduling Management icon 361 represents a scheduler.

[symbol] Analytics icons 371 directs the user to various analytics.

The roadmap icon 381 directs the user to a roadmap of the system.

It will be understood that each of these icons is provided for example only. More, fewer or different icons may be provided without departing from the scope of the present inventive concept. To summarize, when one or more of the icons are selected, the described feature becomes available to the responsive to the selection.

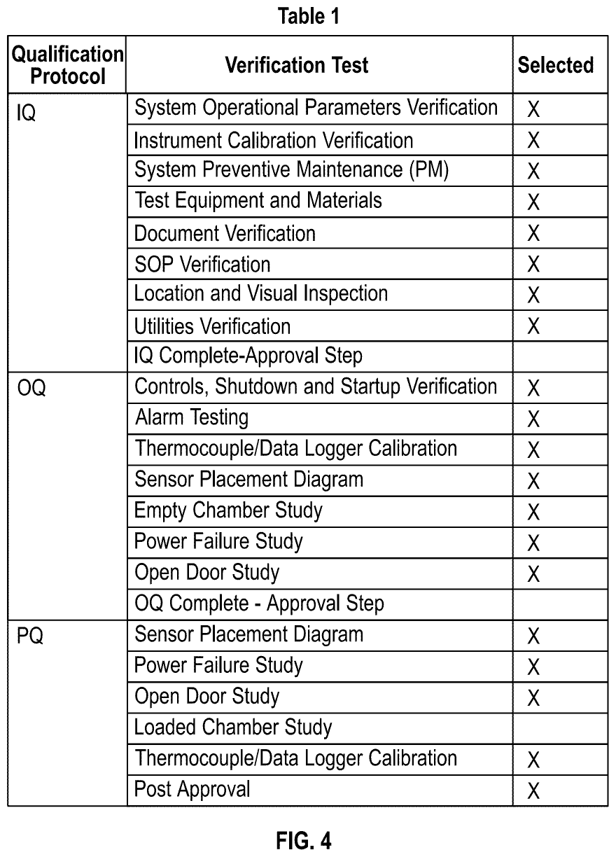

In some embodiments of the present inventive concept, validation protocols are pre-approved by the system owner to reflect the QMS requirements. Example verification tests that have been selected for their respective protocols are listed in Table 1 of FIG. 4. These verification tests are provided as examples only and do not limit embodiments of the present inventive concept.

In embodiments directed to controlled temperature units (CTUs), CTUs can be added to the system. The CTU Management section of the computer system is used as a database for all CTUs eligible for validation. For example, in some embodiments, to add a CTU for validation a “button,” for example, an [symbol] button may be selected and then the user is able to enter the CTU details. It will be understood that this button is provided as an example only, embodiments are not limited thereto. Furthermore, as discussed above, validation embodiments discussed herein are not limited to CTUs. Once the CTU is added as user may verify all information in the CTU profile is accurate and verify that the CTU is active in the CTU Management section prior to initiating a validation study.

In further embodiments, test equipment may be added to the system. For example, the Test Instrument Management area may be used as a database for instruments/equipment used in association with validation studies. To add new test equipment to the database, a “button,” for example, an [symbol] button may be selected. Once selected, it is verified that Add Test Equipment Details (single) the instruments/equipment used in association with the validation study are active in the database and have a current calibration recorded (if necessary).

In some embodiments, Reference Documents may be added. The Document Management area may be used as a database for records, procedures, standards and the like to be referenced during the execution of the validation study. To add a new document, a button, for example, an [symbol] button may be selected. As user confirms that the document is active and completes the required document details. It will be understood that in some embodiments, the document management area may only be used as a database for documents, not for version or approval management of external documents.

Once all the details have been taken care of, a Validation Study in accordance with embodiments discussed herein may be initiated. For example, from the Validation Home page, the [symbol] button (in the top right) 391 may be selected. In the Start New Validation window, the required fields may be completed for the desired validation study. Required fields may change from customer to customer and product to product. However, with the interface Required fields may be noted, for example, by a colored star (*), for example, a red star, which indicates that the field is required to the user. For example, some required fields include testing protocols, validation names, equipment types and IDs and the like.

The testing protocols may include, for example, Installation Qualification (IQ), Installation and Operational Qualification (IOQ), Installation, Operational and Performance Qualification (IOPQ) and Requalification (RQ). The validation name may include the Name of Validation study (i.e. IOQ for the Ultra Low Freczer). In some embodiments, the naming of studies may follow a standard convention, for example, [SOP XXX]. The equipment type may be selected from a drop-down menu containing available Equipment Types from CTU Management. The Equipment ID may be selected from a drop-down menu containing available Equipment IDs from CTU Management. Once all required fields are selected or provided, a study may be initiated. For example, the button [symbol] may be selected to initiate Qualification the study.

It will be understood that the protocols in accordance with some embodiments of the present inventive concept are built based on equipment type and the required testing configuration is developed based on the equipment type.

Based on the qualification study(s) selected, the user may be able to execute the pre-configured and pre-approved test protocol verifications for a specified Equipment. Prior to completing the test protocols, the user should thoroughly read the step instructions and acceptance criteria for the test verification. Each required (*) field may be completed with the actual results of the verification test. Once the actual results are completed, the [symbol] button may be selected to save inputs. An e-signature may be provided where required. In some embodiments, application of the e-signature requires two (2)-factor authentication PIN code. In some embodiments, the two-factor authentication may be in the form of an emailed OTP as discussed above. If the PIN code is no longer active, the user can request a PIN when applying an e-signature. The signer must generally also provide ‘Signing reason’ at time of applying c-signature. Any method of two-factor authentication may be used without departing from the scope of the present inventive concept. For example, in some embodiments a user may generate a PIN code and it will be stored in their profile. This stored code may serve as another level of authentication.

In embodiments where approved protocols require the IQ or OQ approval, the protocol is routed to designated personnel for approval authorization for the user continue execution of the protocol. Once the protocol is complete, the user routes the validation study report for approval to the designated personnel. Designated personnel may vary by company and can be added or deleted at will.

Once the user has completed a section and applied an e-signature, the executed verification test cannot be modified without re-opening the test. To re-open a verification test, the [symbol] button may be selected at the top of the desired verification test section. If the test is reopened, the reason for the update must be recorded at the bottom of the verification test. All changes to previously completed verification test steps are also captured in the audit trail.

Deviations are initiated when the test result is found to be outside of pre-determined acceptable criteria (which can be defined based on the circumstances) or deviates from the Standard Operating Procedure (SOP) for that test. In some embodiments, the user can issue a deviation by selecting the red [symbol] button in the top right corner of the verification test. When this button is selected, the deviation form is opened, and all required fields must be completed and routed to a delegate for approval. Once the deviation is approved, the deviation is considered closed. Following the completion of the validation study and approval by designated personnel, a PDF copy of the completed validation study is made available for export.

It will be understood that all the virtual “buttons” discussed above are not limited to the specific naming conventions discussed above. The buttons can have any name that makes their function obvious without departing from the scope of the present inventive concept.

Some embodiments of the present inventive concept provide an audit trail that is a 21 CFR, part 11 compliant application with computer-generated, timestamps. There may be two types of audit trails, security events and document activity.

A validator Qualification Summary Report may be generated in some embodiments. Reports may have any form capable of conveying the necessary information without departing from the scope of the present inventive concept.

Some embodiments of the present inventive concept provide a System Requirements Specification (SRS) to define the functional requirements for the application, which has been developed to facilitate the electronic documentation of, for example, controlled temperature unit (CTU) validation studies. Thus, the document serves as a comprehensive guide to testers and end-users, outlining the intended features, functionalities, and performance expectation of the system. The SRS should include, at least, the following: Representative end-user expected operation; description of the required system performances to be tested; defined business acceptance criteria, operations, and critical parameters; maintenance (backup and restore) requirements are considered beyond typical usage testing but should be included as part of system validation; appropriate Regulatory requirements; documentation/procedure requirements; training requirements and the like

In some embodiments, the present inventive concept is designed to streamline the validation process for an asset or process, for example, controlled temperature units. Controlled temperature units within the scope of the application are, as discussed above, refrigerators; freezers; ultra-low freczers; walk-in controlled temperature storage rooms; LN2 Freezers and incubators.

The inventive concept discussed herein is a web-based software application designed to streamline the validation process for controlled temperature units. The application provides creation and management of validation study data; report generation features; data import functions; data parsing functions; administrative controls (Users, Roles etc.); and regulatory compliance (Audit Trails, E-Signatures etc.).

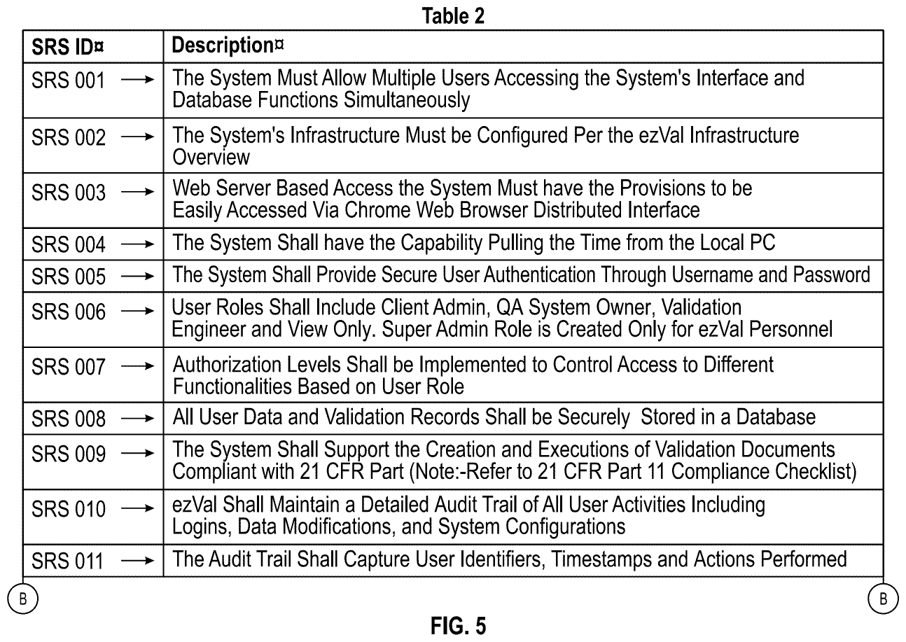

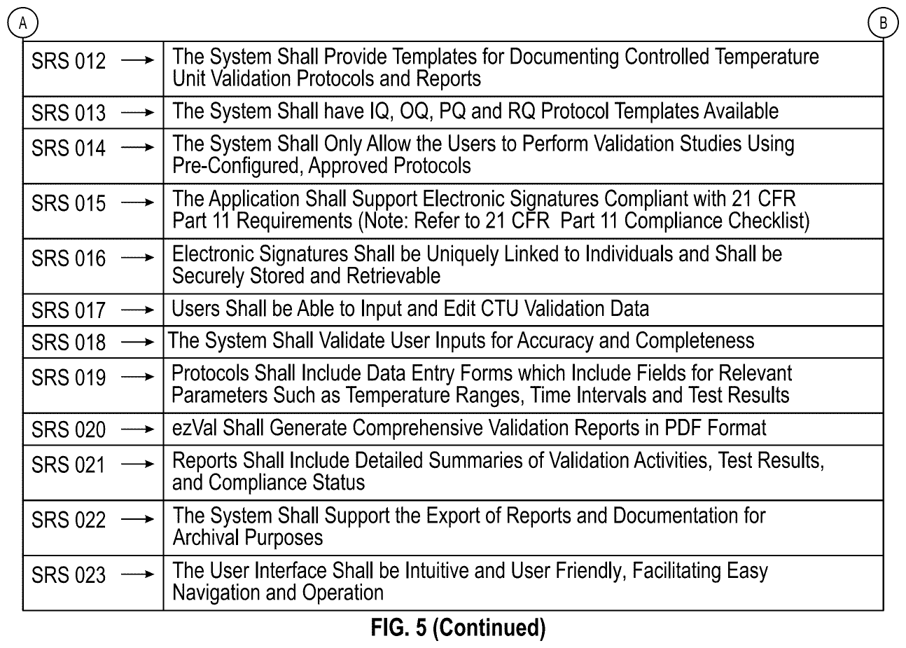

Table 2 of FIG. 5 contains a list of example application and implementation requirements for the application software in accordance with embodiments discussed herein. Each subsection herein will define the overall requirements for the operation of the application as specified for the module application functions noted in the subsection title.

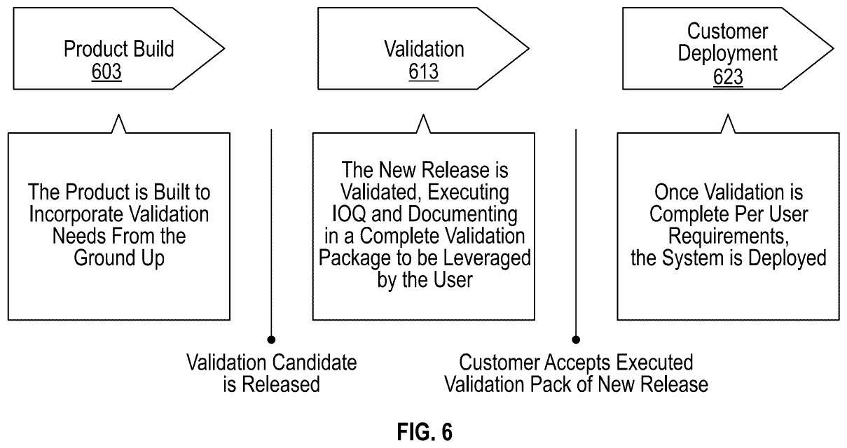

Referring now to FIG. 6, a flowchart illustrating processes in accordance with some embodiments of the present inventive concept will be discussed. As illustrated, the validation solution is built from the ground up (block 603), validated (block 613) and then deployed (block 623). In particular, the product is built to incorporate the validation needs of the user/customer from the ground up (block 603). Then the released validation candidate is validated by executing IOQ and documenting in a complete validation package that can be leveraged by the user (block 613). Once the user accepts the executed validation pack, the validation pack is deployed per the user requirements (block 623). The diagram of FIG. 6 illustrates the high level process that is repeatable and allows for agile development.

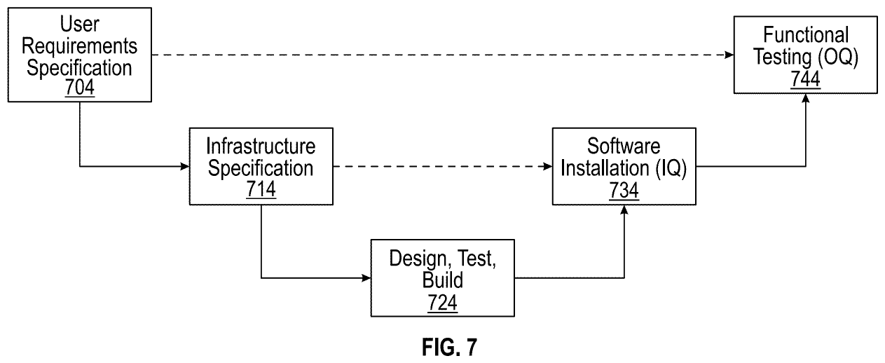

Referring now to FIG. 7, a chart illustrating an example validation testing process will be discussed. The validation testing documentation includes software design specification, IOQ Test Scripts, fully executed IOQ documentation and Regression Testing (when applicable). In particular, user requirements (block 704), infrastructure specifications (block 714), design, test and build the system (block 724) and software installation (IQ) (block 734) and finalizing with functional testing (OQ) (block 744).

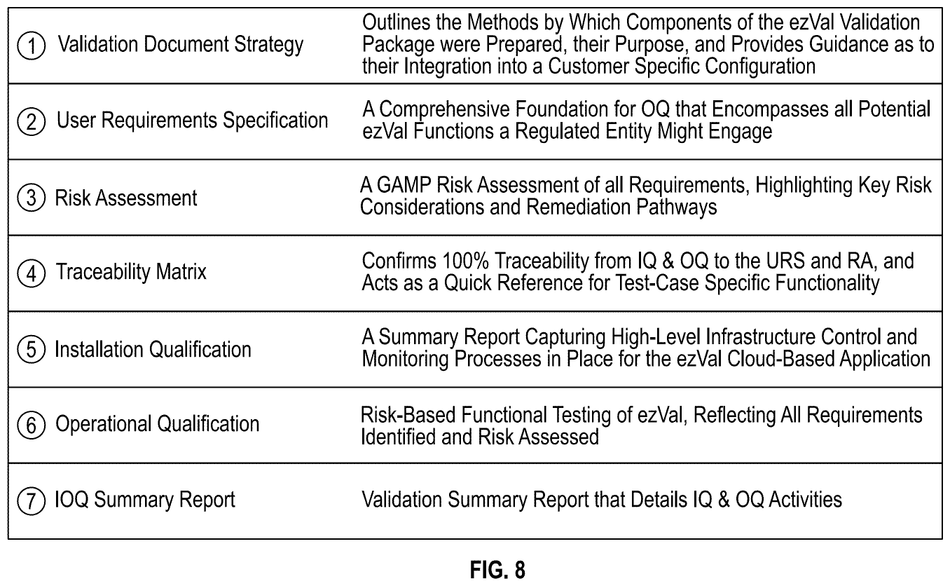

FIG. 8 is a chart illustrating the various steps in the full IOQ documentation in accordance with some embodiments of the present inventive concept. As illustrated, Step 1 is the validation document strategy that outlines the methods by which components were prepared, their purpose, and provides guidance as to the component's integration into a customer specific environment. Step 2 is directed to user requirements specification that includes a comprehensive foundation for OQ that encompasses all potential function a regulated entity might engage. Step 3 is directed to risk assessment that includes a Good Automated Manufacturing Practice (GAMP) risk assessment of all requirements, highlighting key risk considerations and remediation pathways. Step 4 is directed to the traceability matrix that confirms 100 percent traceability from IQ to OQ to the URS and RA and acts as a quick reference for test-case specific functionality. Step 5 is directed to installation qualification that includes a summary report capturing high-level infrastructure control and monitoring processes in place for the cloud-based application in accordance with embodiments discussed herein. Step 6 is directed to the operational qualification that includes risk-based functional testing, reflecting all requirements identified and risks assessed. Finally, Step 7 is directed to IOQ summary report that includes a validation summary report that details IQ and OQ activities.

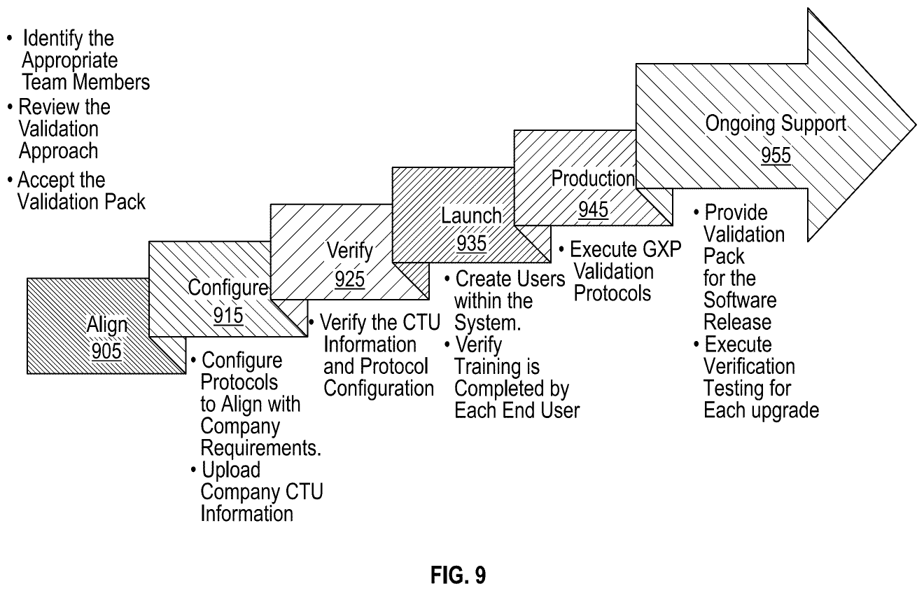

FIG. 9 is a diagram illustrating the deployment methodology in accordance with some embodiments of the present inventive concept. As illustrate, the deployment methodology includes the following steps align 905, configure 915, verify 925, launch 935, production 945 and ongoing support 955. In particular, the details of the project are aligned by identifying the appropriate team members, reviewing the validation approach and accepting the validation pack (block 905). The protocols are configured to align with the user's requirements and are uploaded to the CTU in these embodiments (block 915). The CTU information and protocol information is verified (block 925). Users are created in the system and it is verified that training has been completed by each end user (block 935). The validation protocols are executed (block 945). The validation pack is provided for the software release and verification testing is executing for each upgrade (block 955).

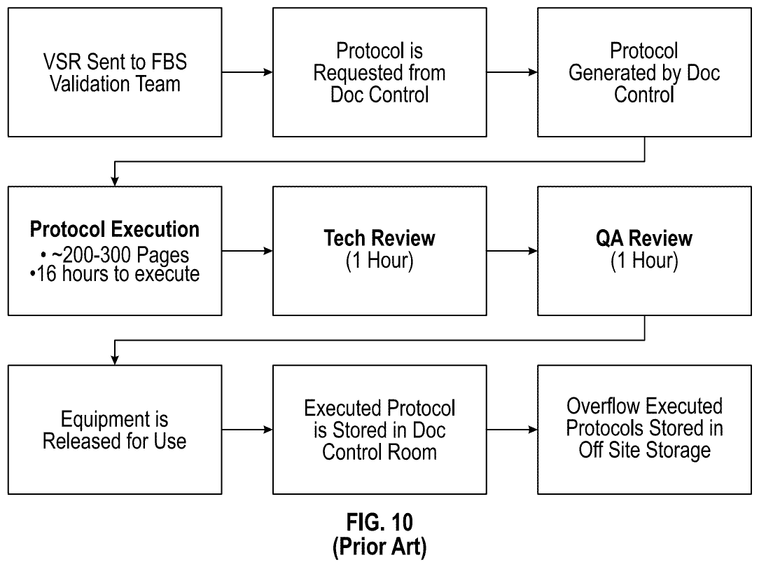

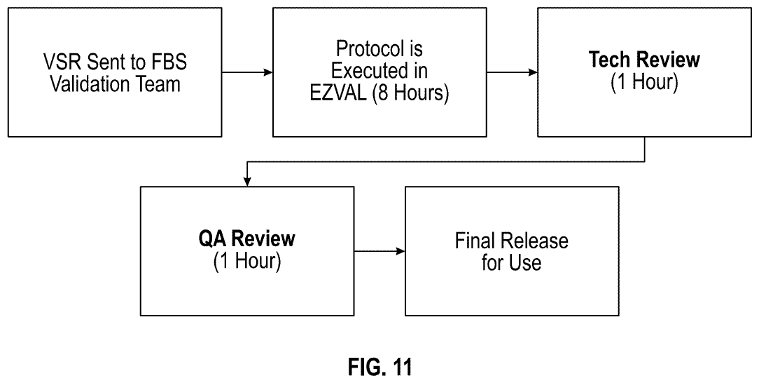

FIG. 10 is a flowchart illustrating processing steps in a conventional paper validation process. As is clear from the nine step process illustrated in FIG. 10, the conventional process is length in cumbersome Contrast the nine steps of FIG. 10 with the 5 steps in accordance with embodiments of the present inventive concept illustrated in FIG. 11. FIG. 11 is a flowchart illustrating processing steps in the computerized process in accordance with embodiments discussed herein. It is clear that the computerized system in accordance with embodiments discussed herein is more efficient and cost effective. In particular, embodiments of the present inventive concept offer less steps as well as automated processes that occur more quickly.

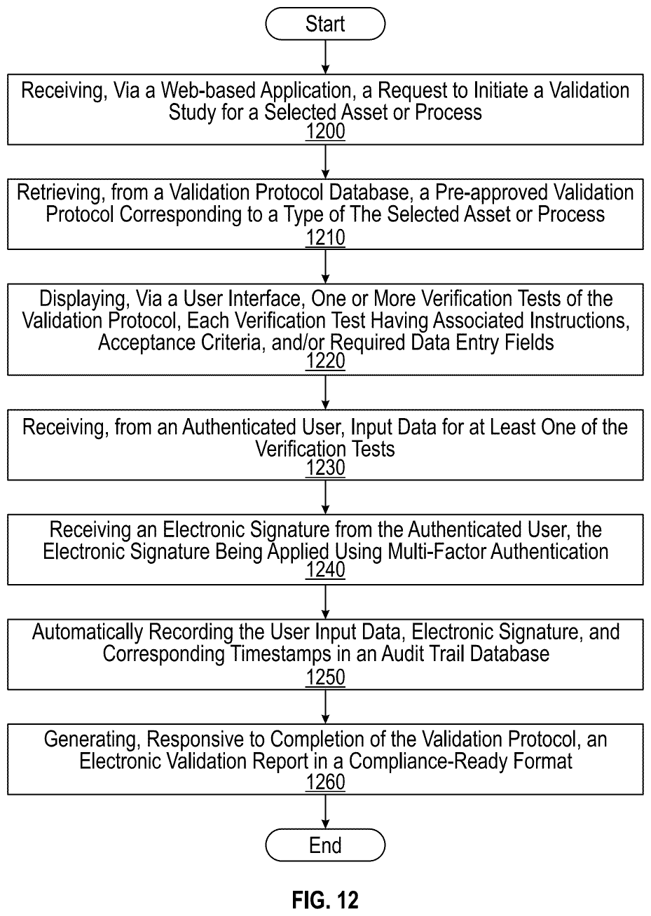

Referring now to FIG. 12, a flowchart illustrating various operations in accordance with some embodiments of the present inventive concept will be discussed. It will be understood that the processes steps of FIG. 12 illustrate one order of steps to provide examples of implementation of embodiments of the present inventive concept and, therefore, embodiments are not limited thereto.

As illustrated in FIG. 12, operations for performing regulatory validation processes in accordance with embodiments discussed herein begin at block 1200 by receiving, via a web-based application, a request to initiate a validation study for a selected asset or process. As discussed above, the asset or process can include any asset or process that needs to be validated. A pre-approved validation protocol corresponding to a type of the selected asset or process is retrieved from a validation protocol database (block 1210). One or more verification tests of the validation protocol are displayed via a user interface (block 1220). Each of the verification tests have associated instructions, acceptance criteria, and/or required data entry fields discussed above. Receiving input data from an authenticated user for at least one of the verification tests (block 1230). An electronic signature is received from the authenticated user (block 1240). The electronic signature is applied using multi-factor authentication. As discussed above, any multifactor authentication process may be used without departing from the scope of the present inventive concept. For example, the multi-factor authentication may include sending a one-time password (OTP) to a registered communication address of the authenticated user.

The user input data, electronic signature, and corresponding timestamps are automatically recorded in an audit trail database (block 1250). Responsive to completion of the validation protocol, an electronic validation report in a compliance-ready format is generated (block 1260). In some embodiments, the electronic validation report may be stored in a cloud-based data storage service with geo-redundant backup.

The selected asset or process may include at least one of: laboratory equipment, manufacturing equipment, a production process, a shipping method, a computerized system, or a utility system.

In some embodiments, the validation protocol may be pre-configured based on quality management system (QMS) requirements related to a specific organization.

A deviation request may be received when test results fall outside predetermined acceptable criteria. The deviation request may be routed to designated personnel for review and approval. The deviation approval data may be stored in the audit trail database.

Role-based access permissions may be assigned to the authenticated user prior to initiating the validation study.

The compliance-ready format may be a portable document format (PDF) file generated automatically by the application. Any PDF format may be used without departing from the scope of the present inventive concept.

Historical validation data may be analyzed using a machine learning model to recommend a validation protocol for the selected asset or process. The one or more verification tests may include dynamically generated acceptance criteria predicted by a trained machine learning algorithm based on asset-specific operating history. The trained machine learning algorithm may be trained using a plurality of prior validation studies across multiple organizations to predict optimal test sequences that minimize total validation time while maintaining compliance. The machine learning model may be retrained with results of completed validation studies to improve accuracy of future protocol recommendations.

In some embodiments, anomalies in received input data may be automatically detected using an artificial intelligence (AI) anomaly detection model. A deviation request may be generated responsive to detection of the anomalies. The AI detection model may provide real-time guidance to the authenticated user during execution of the validation protocol based on context-aware analysis of current test results.

In some embodiments, a natural language processing model may be used to parse unstructured regulatory guidance documents and extract protocol requirements for storage in the validation protocol database.

As discussed above, embodiments of the present inventive concept may used with any asset or process in need of validation. Some embodiments of the present inventive concept provide a business to business (B2B) software as a service (SaaS) platform that addresses critical gaps in conventional validation by leveraging an artificial intelligence (AI)-driven architecture to dynamically generate executable and reviewable test protocols tailored to regulatory requirements. Unlike existing digital solutions that primarily digitize documentation workflows, embodiments of the present inventive concept automate the entire validation lifecycle by integrating directly with test instruments and Asset Management Systems to reduce, or possibly, eliminate manual scripting and reduce human error.

Persistent bottlenecks in manual and fragmented validation processes across biotech and pharmaceutical companies often result in costly delays, compliance risks, and dependence on highly experienced personnel. Existing solutions, such as Kneat and ValGenesis, focus on documentation rather than holistic validation automation.

As discussed above, embodiments of the present inventive concept utilize modular, AI-based dynamic template generation, automated regulatory traceability matrices and automated parsing of instrument data into reports. This allows the platform to automatically map validation steps to compliance standards (e.g., 21 CFR Part 11, Annex 11) without manual intervention. These features reduce validation cycle times by 50-60% compared to traditional and paper-based methods. By addressing validation holistically, covering test creation, execution, and review, embodiments of the present inventive concept reduce, and possibly minimize, reliance on consultants and significantly lowers operational costs.

Embodiments of the present inventive concept focus on transforming the validation process into a scalable, data-driven, and automated workflow designed for digital-native users with minimal regulatory expertise. The platform's capability to create modular test protocols dynamically fills a key scientific knowledge gap in current validation practices, ensuring accuracy and traceability without requiring extensive user input. Embodiments discussed herein enable companies to validate systems more efficiently while maintaining high compliance standards, fundamentally changing how validation is conducted across industries.

In particular, embodiments of the present inventive concept may provide an AI-driven validation platform including: 1) data integration, 2) dynamic test generation, 3) regulatory traceability, and 4) usability.

Data Integration. (what are your subtasks and approach?): Embodiments of the present inventive concept integrate with diverse test instruments and Asset Management Systems to automate data collection and validation execution. Current manual methods are prone to errors, but achieving real-time, accurate data flow across different devices poses technical risks.

Some embodiments of the present inventive concept provide dynamic test generation engine, which creates modular, site-specific protocols based on equipment classifications and regulatory requirements. An AI-based system is provided that handles variability across equipment and regulations without human oversight. The system uses feedback from (x) early adopters during (x) pilot studies to test and enhance the algorithm, ensuring accuracy and flexibility (how will you quantitate) What makes a go-no go decision?

Embodiments of the present inventive concept automating regulatory traceability matrices to align test protocols with compliance standards like 21 CFR Part 11 and EU Annex 11. Manual mapping introduces risks of non-compliance and delays. By leveraging AI, these matrices may be generated automatically, and the system's reliability may be validated in handling different validation scenarios through structured testing and feedback loops.

Finally, embodiments of the present inventive concept ensure usability for digital-native users with minimal validation experience. In particular, A/B testing and user studies were conducted during pilot deployments to refine the interface, providing step-by-step guidance that reduces user error while maintaining compliance.

The scientific approach discussed herein combining modular test generation with automated regulatory mapping pushes beyond incremental improvements by transforming validation from a fragmented, manual process into a streamlined, automated system. Embodiments discussed herein offer a durable competitive advantage through faster, more cost-effective, and highly scalable validation solution.

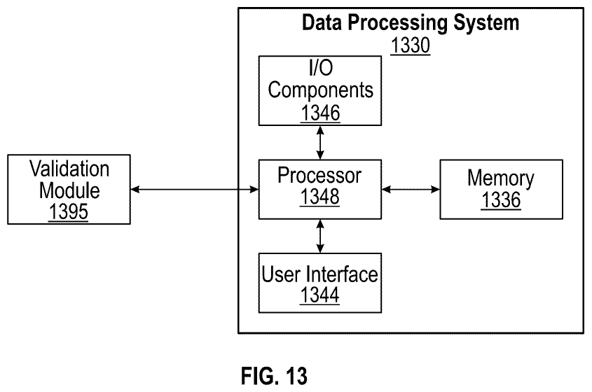

Referring now to FIG. 13, an example of a data processing system 1330 suitable for use with any of the examples described above. Although the example data processing system 1330 is shown as in communication with the validation module 1395 in accordance with embodiments of the present inventive concept, the data processing system 1330 may also be part any other component of the system without departing from the scope of the present inventive concept. In some examples, the data processing system 1330 can be any suitable computing device for performing operations according to the embodiments discussed herein.

As illustrated, the data processing system 1330 includes a processor 1348 communicatively coupled to I/O components 1346, a user interface 1344 and a memory 1336. The processor 1348 can include one or more commercially available processors, embedded processors, secure processors, microprocessors, dual microprocessors, multi-core processors, other multi-processor architectures, another suitable processing device, or any combination of these. The memory 1336, which can be any suitable tangible (and non-transitory) computer-readable medium such as random access memory (RAM), read-only memory (ROM), erasable and electronically programmable read-only memory (EEPROMs), or the like, embodies program components that configure operation of the data processing system 1330.

I/O components 1346 may be used to facilitate wired or wireless connections to devices such as one or more displays, game controllers, keyboards, mice, joysticks, cameras, buttons, speakers, microphones and/or other hardware used to input or output data. Memory 1036 represents nonvolatile storages such as magnetic, optical, or other storage media included in the data processing system and/or coupled to processor 1348.

The user interface 1344 may include, for example, a keyboard, keypad, touchpad, voice activation circuit, display or the like and the processor 1348 may execute program code or instructions stored in memory 1336.

It should be appreciated that data processing system 1330 may also include additional processors, additional storage, and a computer-readable medium (not shown). The processor(s) 1348 may execute additional computer-executable program instructions stored in memory 1336. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xcon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C #, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

As discussed briefly above, some embodiments of the present inventive concept provide a validation approach that reduces the burden on the customer, fully verifies the products per current standards and recommendations and provides accelerated validation within quality operations. Embodiments of the present inventive concept may provide both cost and time savings, easier Audit reporting for clients and allows for Validation FTE's to focus on critical project support other than CTUS.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A computer-implemented method for performing a regulatory validation process, the method comprising:
receiving, via a web-based application, a request to initiate a validation study for a selected asset or process;
retrieving, from a validation protocol database, a pre-approved validation protocol corresponding to a type of the selected asset or process;
displaying, via a user interface, one or more verification tests of the validation protocol, each verification test having associated instructions, acceptance criteria, and/or required data entry fields;
receiving, from an authenticated user, input data for at least one of the verification tests;
receiving an electronic signature from the authenticated user, the electronic signature being applied using multi-factor authentication;
automatically recording the user input data, electronic signature, and corresponding timestamps in an audit trail database; and
generating, responsive to completion of the validation protocol, an electronic validation report in a compliance-ready format.

2. The method of claim 1, wherein the selected asset or process comprises at least one of: laboratory equipment, manufacturing equipment, a production process, a shipping method, controlled temperature units (CTUs) a computerized system, or a utility system.

3. The method of claim 1, further comprising storing the electronic validation report in a cloud-based data storage service with geo-redundant backup.

4. The method of claim 1, wherein the validation protocol is pre-configured based on quality management system (QMS) requirements related to a specific organization.

5. The method of claim 1, further comprising:
receiving a deviation request when test results fall outside predetermined acceptable criteria;
routing the deviation request to designated personnel for review and approval; and
storing deviation approval data in the audit trail database.

6. The method of claim 1, wherein the multi-factor authentication comprises sending a one-time password (OTP) to a registered communication address of the authenticated user.

7. The method of claim 1, further comprising assigning role-based access permissions to the authenticated user prior to initiating the validation study.

8. The method of claim 1, wherein the compliance-ready format is a portable document format (PDF) file generated automatically by the application.

9. The method of claim 1, further comprising analyzing historical validation data using a machine learning model to recommend a validation protocol for the selected asset or process.

10. The method of claim 1, wherein the one or more verification tests include dynamically generated acceptance criteria predicted by a trained machine learning algorithm based on asset-specific operating history.

11. The method of claim 10, wherein the trained machine learning algorithm is trained using a plurality of prior validation studies across multiple organizations to predict optimal test sequences that minimize total validation time while maintaining compliance.

12. The method of claim 10, further comprising retraining the machine learning model with results of completed validation studies to improve accuracy of future protocol recommendations.

13. The method of claim 1, further comprising:
automatically detecting anomalies in received input data using an artificial intelligence (AI) anomaly detection model; and
generating a deviation request responsive to detection of the anomalies.

14. The method of claim 13, wherein the AI detection model provides real-time guidance to the authenticated user during execution of the validation protocol based on context-aware analysis of current test results.

15. The method of claim 1, further comprising using a natural language processing model to parse unstructured regulatory guidance documents and extract protocol requirements for storage in the validation protocol database.

16. A system for performing a regulatory validation process, the system comprising:
a processor; and
a memory that stores instructions that, when executed by the processor, cause the system to:
receive, via a web-based application, a request to initiate a validation study for a selected asset or process;
retrieve, from a validation protocol database, a pre-approved validation protocol corresponding to a type of the selected asset or process;
display, via a user interface, one or more verification tests of the validation protocol, each verification test having associated instructions, acceptance criteria, and/or required data entry fields;
receive, from an authenticated user, input data for at least one of the verification tests;
receive an electronic signature from the authenticated user, the electronic signature being applied using multi-factor authentication;
automatically record the user input data, electronic signature, and corresponding timestamps in an audit trail database; and
generate, responsive to completion of the validation protocol, an electronic validation report in a compliance-ready format.

17. The system of claim 16, wherein the instructions further cause the system to:
receive a deviation request when test results fall outside predetermined acceptable criteria;
route the deviation request to designated personnel for review and approval; and
store deviation approval data in the audit trail database.

18. The system of claim 16, wherein the instructions further cause the system to:
automatically detect anomalies in received input data using an artificial intelligence (AI) anomaly detection model; and
generate a deviation request responsive to detection of the anomalies.

19. A non-transitory computer-readable medium storing instructions that, when executed by a processor, cause a computing system to:
receive, via a web-based application, a request to initiate a validation study for a selected asset or process;
retrieve, from a validation protocol database, a pre-approved validation protocol corresponding to a type of the selected asset or process;
display, via a user interface, one or more verification tests of the validation protocol, each verification test having associated instructions, acceptance criteria, and/or required data entry fields;
receive, from an authenticated user, input data for at least one of the verification tests;
receive an electronic signature from the authenticated user, the electronic signature being applied using multi-factor authentication;
automatically record the user input data, electronic signature, and corresponding timestamps in an audit trail database; and
generate, responsive to completion of the validation protocol, an electronic validation report in a compliance-ready format.

20. The non-transitory computer-readable medium of claim 19, wherein the instructions further cause the system to:
receive a deviation request when test results fall outside predetermined acceptable criteria;
route the deviation request to designated personnel for review and approval; and
store deviation approval data in the audit trail database.
